(19) United States
(12) Patent Application Publication
(10) Pub. No.: US 2008/0217569 A1
(43) Pub. Date: Sep. 11, 2008

(54) Low Torque Gate Valve Mechanism

(75) Inventor: David Holliday, Spring, TX (US)

Correspondence Address: BAKER BOTTS, LLP, 910 LOUISIANA, HOUSTON, TX, 77002-4995, US

(73) Assignee: Dril-Quip, Inc., Houston, TX (US)

(21) Appl. No.: 12/042,199

(22) Filed: Mar. 4, 2008

Related U.S. Application Data
(60) Provisional application No. 60/892,942, filed on Mar. 5, 2007.

(51) Int. Cl. F16K 3/30

(52) U.S. Cl. 251/248; 251/326; 137/13

(57) ABSTRACT

A gate valve apparatus provides a manually operated gate valve with an operation mechanism that reduces the force required to actuate the gate valve and minimizes the number of handwheel turns required. Disclosed is a gate valve apparatus including a valve body, a bonnet, a gate, a ball screw arrangement, a gear reducer arrangement and a handwheel. The ball screw arrangement, gear reducer arrangement, and the handwheel are associated with the valve stem and gate such that rotational force applied to the handwheel is converted by the gear reducer arrangement and the ball screw arrangement into linear force applied to the valve stem and then to the gate.

### CROSS REFERENCE TO RELATED APPLICATION

This application claims the benefit of U.S. Provisional Application No. 60/892,942 filed on Mar. 5, 2007.

### BACKGROUND

1. Field of the Invention

The present invention is related to gate valve assemblies.

2. Description of the Related Art

Gate valves are commonly used in a number of industries to control the flow of fluids. Gate valves are classified as either rising stem gate valves or non-rising (or rotating) stem gate valves. A rising stem gate valve has a stem fixed to the gate such that the stem and gate move together. A non-rising stem gate valve has a stem threaded into the gate such that rotation of the stem, rather than axial movement, causes the gate to move axially.

Rising stem gate valves may be further classified as either unbalanced stem gate valves or balanced stem gate valves. An unbalanced stem gate valves has a single stem associated with the gate. A balanced stem gate valve has a second stem attached to the gate at the end opposite the first stem. The diameters of the two stems are chosen such that the force components of pressurized fluid acting on the two stems are balanced. Thus, the force components bearing on one stem are ideally canceled out by the force components bearing on the opposite stem.

Gate valves may be manually actuated by converting the rotational motion of a handwheel into the axial motion of the stem. As a general rule, it is desirable for the rim pull force, the force applied to the handwheel rim in order to operate the valve, not to be excessive with some wanting the value not to exceed 80 lbs. The rim pull force is related to the valve's operating torque. The handwheel may be directly threaded into the stem, but, for large or high pressure valves, such an arrangement can require impractically large amounts of rim pull force on the handwheel, or an impractically large diameter handwheel. Valve operation mechanisms with roller screws and ball screw devices have been used to reduce torque, but such mechanisms either do not facilitate acceptable levels of rim pull force or they require an excessive number of turns to operate. Other valve operation mechanisms have used Acme threads with bevel, spur or worm gear torque reduction boxes, but such devices have the disadvantage of requiring a high gear ratio and a correspondingly high number of turns of the handwheel. Thus, some prior art approaches to reducing torque in manually operated gate valves have resulted in meeting desired torque levels, but such approaches nonetheless have the disadvantage of requiring an unacceptable number of handwheel turns for operation.

### SUMMARY

These and other disadvantages in the prior art are overcome by providing a gate valve apparatus according to the present invention. In one embodiment of the present invention, the gate valve apparatus includes: a gear set, a ball nut, a plurality of balls, a shaft, a stem and a gate. The gear set includes a plurality of gears arranged to produce an output torque such that the output torque is greater than an input torque. The ball nut is disposed with respect to the gear set such that the output torque causes rotation of the ball nut. The shaft, the plurality of balls and the ball nut are arranged so that rotation of the ball nut relative to the shaft causes axial movement of the shaft. The stem is connected to the shaft. The gate is disposed with respect to the stem so that axial movement of the stem causes movement of the gate.

In another embodiment of the present invention, the gate valve apparatus includes: a valve body, a bonnet, two seats, a gate, a valve stem, a shaft, a ball nut, a plurality of balls, a handwheel and a gear reducer arrangement. The valve body includes a flowway extending completely therethrough and a valve body cavity that extends at least partially therethrough and intersects the flowway. The bonnet is sealably connected to the valve body over the valve body cavity. The two seats in sealable contact with the valve body. The gate is in sealable contact with the seats and is movable within the valve body cavity between at least two positions so that the gate at least partially allows or at least partially restricts flow through the flowway. The valve stem is connected to the gate and sealably extends through the bonnet. The shaft is associated with the valve stem so that linear force applied to the shaft is transferred to the valve stem. The plurality of balls interconnect the ball nut and the ball screw shaft such that rotation relative to the ball nut and the ball screw shaft causes axial movement of the ball screw shaft. The gear reducer arrangement is associated with the handwheel and the ball nut such that a rotational force input applied to the handwheel is converted into a rotational force output applied to the ball nut.

According to another embodiment of the present invention, there is provided a method for controlling fluid flow through a flowway, the method having the following steps: applying a rotational force input to a wheel, wherein the rotational force input causes a gear reducer to produce a rotational force output; transferring the rotational force output of the gear reducer to one of a ball nut and a shaft; converting the rotational force output to a linear force with a plurality of balls coacting with at least one of the ball nut and the shaft; applying the linear force to a gate; and moving the gate between at least two positions so that the gate at least partially allows or at least partially restricts flow through the flowway.

The present invention provides a manually operated gate valve with an operation mechanism, as well as a method for controlling fluid flow through a flowway, that reduces the torque required to actuate the gate valve and minimizes the number of handwheel turns required. In comparison to prior art gate valves, one advantage of the present invention is a lower torque requirement for opening and closing the valve. Another corresponding advantage of the present invention is that fewer turns are required to stroke the valve, which allows for faster valve actuation time assuming the handwheel is turned at a constant rate. As a consequence, the present invention minimizes the potential for gate erosion due to abrasives during transitions between open and closed positions. Yet another advantage of the present invention is the ergonomic improvement corresponding to a minimized handwheel torque and a minimized number of handwheel turns. These and other objects and advantages of the present invention will be apparent from the following.

### BRIEF DESCRIPTION OF THE DRAWINGS

The following figures form part of the present specification and are included to demonstrate certain aspects of the present invention. The present invention may be better understood by reference to these drawings in combination with the description of embodiments presented herein. Consequently, a more complete understanding of the present disclosure and advantages thereof may be acquired by referring to the following description taken in conjunction with the accompanying drawings.

FIG. 1 is a partially cutaway side view of one embodiment of a gate valve in an open position in accordance with the present invention.

FIG. 2 is a partially cutaway side view of one embodiment of a gate valve in a closed position in accordance with the present invention.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention as defined by the appended claims are intended to be covered.

### DETAILED DESCRIPTION

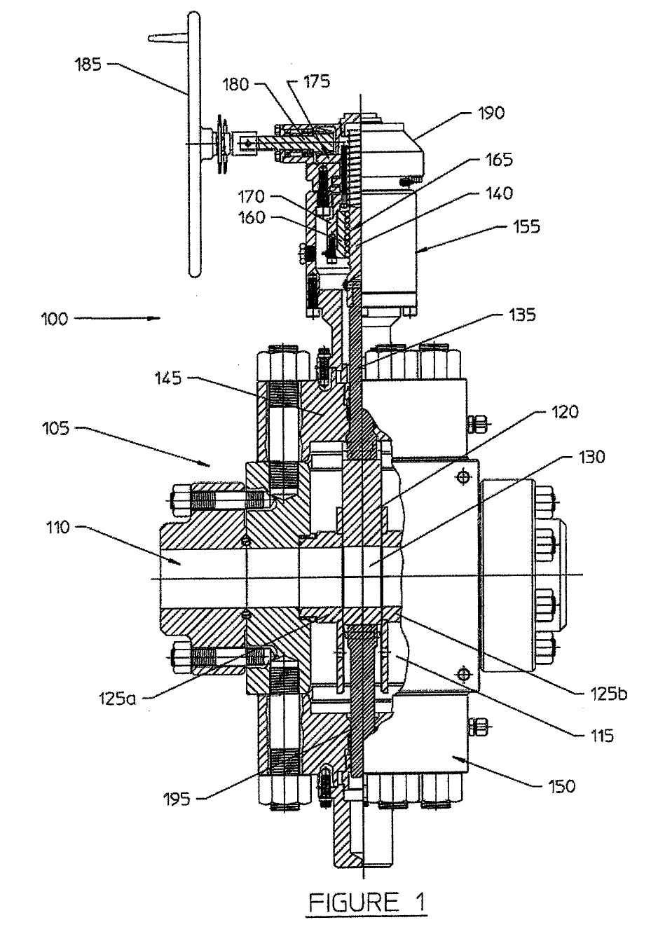

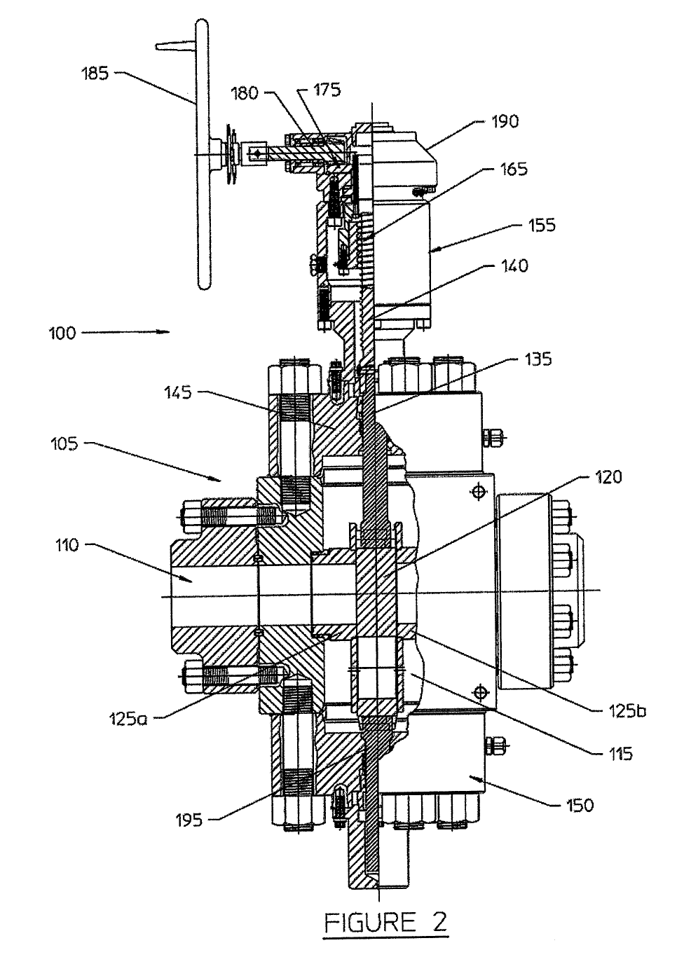

The details of the present invention will now be described with reference to the figure. Referring to FIGS. 1 and 2, shown therein is a gate valve apparatus 100, in accordance with one embodiment of the present invention. A valve body 105 includes a flowway 110 extending completely therethrough. A valve body cavity 115 extends partially through valve body 105 and intersects the flowway 110. A seat 125a and a seat 125b are sealably disposed near the intersection of the flowway 110 and the valve body cavity 115. A bonnet 145 is secured and sealed to the valve body 105 over the valve body cavity 115. An actuator housing 155 is secured to the bonnet 145, and a gear set enclosure 190 is secured to the actuator housing 155.

A gate 120 is sealably and slidably disposed between seats 125a and 125b and is suitable for reciprocal motion between at least two positions such as an open position and a closed position. When the gate valve apparatus 100 is in an open position as shown in FIG. 1, a gate opening 130 substantially aligns with seats 125a and 125b in valve body 105. Seats 125a and 125b are in fluid communication with flowway 110 such that, when the gate valve apparatus 100 is open, fluid passes therethrough. In a closed position as shown in FIG. 2, the gate opening 130 is positioned away from flowway 110, and the gate 120 blocks the flow of fluid through flowway 110.

The gate 120 is connected to a valve stem 135, which extends beyond the valve body cavity 115 and sealably through the bonnet 145. In one embodiment of the gate valve apparatus 100, the gate 120 is also connected to a balancing valve stem 195, which extends beyond the valve body cavity 115 opposite valve stem 135 and sealably through the balance bonnet 150. The diameters of the two stems are chosen such that the force components of pressurized fluid acting on the two stems are balanced.

A ball screw shaft 140 is associated with the valve stem 135 such that linear force applied to the ball screw shaft 140 is transferred to the valve stem 135 and the gate 120. Thus, axial movement of ball screw shaft 140 corresponds to axial movement of the valve stem 135 and the gate 120. The actuator housing 155 extends in surrounding relation to the ball screw shaft 140. The ball screw shaft 140 extends through ball nut 160. The external grooves of the ball screw shaft 140, the internal grooves of the ball nut 160, and the balls 165 act so as to provide a threaded connection. Such a ball screw approach provides for a low friction conversion of the rotation of the ball nut 160 into axial movement of the ball screw shaft 140 and, correspondingly, axial movement of the valve stem 135 and the gate 120. A fixed rotary means 170 is connected to the ball nut 160 and both are suitably supported by bearings to allow rotation with respect to the ball screw shaft 140 while preventing axial motion from the thrust load. As shown in FIGS. 1 and 2, the bearings may be located in the gear housing 190. In one alterative not shown, the bearings may be located between the actuator housing 155 and the rotary means 170. The rotary means 170 is rotatably interconnected to the output of a gear set 175. The gear set 175 is connected to a handwheel 185 via a pinion 180 and is located in gear housing 190. Preferably, the pinion 180 and the gear set 175 are completely supported on roller bearings.

In the normal operation of gate valve apparatus 100, an operator turns the handwheel 185, thereby applying torque that is transferred to the pinion 180, to the gear set 175, to the rotary means 170, and to the ball nut 160. Such a gear reduction arrangement significantly contributes to the reduction in the amount of torque required of an operator in turning handwheel 185. As the ball nut 160 is rotated, the balls 165 and threads of the ball screw shaft 140 convert the rotational force to axial force applied to the ball screw shaft 140. The ball screw also significantly contributes to the reduction in the amount of torque required of an operator in turning handwheel 185. The resulting axial thrust is transferred from the ball screw shaft 140 to the valve stem 135 and to the gate 120. It is through such an assembly that the torque required to actuate the gate valve apparatus 100 is reduced. The number of handwheel turns required is increased but is not excessive. It is not uncommon for highly pressurized fluid in the flowway 110 to contain abrasive particles that have a potential for eroding the gate 120 during the traverse between open and closed positions. The minimized number of turns translates into a faster traverse of the gate 120, and, thus, the potential for gate erosion due to abrasives during transitions is decreased.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A gate valve apparatus comprising:
a gear set comprising a plurality of gears arranged to produce an output torque, wherein the output torque is greater than an input torque;
a ball nut disposed with respect to the gear set such that the output torque causes rotation of the ball nut;
a plurality of balls;
a shaft, wherein the shaft, the plurality of balls and the ball nut are arranged so that rotation of the ball nut relative to the shaft causes axial movement of the shaft;
a stem connected to the shaft;
a bonnet, wherein the stem sealably extends through the bonnet; and
a gate disposed with respect to the stem so that axial movement of the stem causes movement of the gate.

2. The gate valve apparatus of claim 1 further comprising:
a pinion disposed with respect to the gear set so that rotation of the pinion causes the input torque to be applied to the gear set.

3. The gate valve apparatus of claim 2 further comprising:
a wheel, wherein rotation of the wheel causes rotation of the pinion.

4. The gate valve apparatus of claim 1 further comprising:
a valve body including a flowway that extends completely therethrough and a valve body cavity that extends at least partially therethrough and intersects the flowway, wherein the bonnet is sealably connected to the valve body and adjacent to a portion of the valve body cavity;

5. The gate valve apparatus of claim 4 further comprising:
a balance bonnet sealably connected to the valve body and disposed substantially opposite the bonnet; and
a balancing valve stem, wherein the balancing valve stem is connected to the gate and sealably extends at least partially through the balance bonnet.

6. The gate valve apparatus of claim 4 further comprising:
two seats in sealable contact with the valve body, wherein the gate is in sealable contact with the seats and movable within the valve body cavity between at least two positions so that the gate at least partially allows or at least partially restricts flow through the flowway.

7. The gate valve apparatus of claim 1 further comprising:
a fixed rotary member connected to the ball nut.

8. The gate valve apparatus of claim 7 further comprising:
a plurality of bearings supporting the fixed rotary member and the ball nut.

9. The gate valve apparatus of claim 8 further comprising:
a plurality of roller bearings.

10. The gate valve apparatus of claim 9 wherein the gear set is supported by the plurality of roller bearings.

11. A gate valve apparatus comprising:
a valve body including a flowway that extends completely therethrough and a valve body cavity that extends at least partially therethrough and intersects the flowway;
a bonnet sealably connected to the valve body over the valve body cavity;
two seats in sealable contact with the valve body;
a gate in sealable contact with the seats and movable within the valve body cavity between at least two positions so that the gate at least partially allows or at least partially restricts flow through the flowway;
a valve stem that is connected to the gate, wherein the valve stem sealably extends through the bonnet;
a shaft associated with the valve stem so that linear force applied to the shaft is transferred to the valve stem;
a ball nut;
a plurality of balls interconnecting the ball nut and the shaft so that rotation relative to the ball nut and the shaft causes axial movement of the shaft;
a handwheel; and
a gear reducer arrangement associated with the handwheel and the ball nut so that a rotational force input applied to the handwheel is converted to a rotational force output applied to the ball nut.

12. The gate valve apparatus of claim 11 further comprising:
a balance bonnet sealably connected to the valve body and disposed substantially opposite the bonnet.

13. The gate valve apparatus of claim 12 further comprising:
a balancing valve stem, wherein the balancing valve stem is connected to the gate and sealably extends at least partially through the balance bonnet.

14. The gate valve apparatus of claim 11 further comprising:
a fixed rotary member connected to the ball nut.

15. The gate valve apparatus of claim 14 further comprising:
a plurality of bearings supporting the fixed rotary member and the ball nut.

16. The gate valve apparatus of claim 11 further comprising:
a pinion connected to the handwheel.

17. The gate valve apparatus of claim 11 further comprising:
a plurality of roller bearings.

18. The gate valve apparatus of claim 17 wherein the gear reducer arrangement comprises a gear set, wherein the gear set is supported by the plurality of roller bearings.

19. A method for controlling fluid flow through a flowway, the method comprising:
applying a rotational force input to a wheel, wherein the rotational force input causes a gear reducer to produce a rotational force output;
transferring the rotational force output of the gear reducer to one of a ball nut and a shaft;
converting the rotational force output to a linear force with a plurality of balls coacting with at least one of the ball nut and the shaft;
applying the linear force to a gate; and
moving the gate between at least two positions so that the gate at least partially allows or at least partially restricts flow through the flowway.

20. A method for controlling fluid flow through a flowway as claimed in claim 19, wherein the transferring a rotational force output of the gear reducer arrangement to one of the ball nut and the shaft comprises preventing the other of the ball nut and the shaft from rotating.
